(19) United States
(12) Patent Application Publication
(10) Pub. No.: US 2008/0215664 A1
(43) Pub. Date: Sep. 4, 2008

(54) OCCASIONALLY CONNECTED EDGE APPLICATION ARCHITECTURE

(75) Inventors: Erik Roser Dibbern, Hillerod (DK); Ricky Kaare Rasmussen, Frederiksberg (DK); Laurent Lopez, Kastrup (DK); Bjarne Schon, Naerum (DK)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/680,692

(22) Filed: Mar. 1, 2007

(51) Int. Cl. G06F 15/16

(52) U.S. Cl. 709/202

(57) ABSTRACT

User devices may have connectivity with a backend server only occasionally. Provided is a communication means for such user devices to operate offline, when connectivity is unavailable, and to seamlessly transition to online connectivity when it is available. At least a subset of information from the backend server is communicated to the user device to enable the user to perform functions with the device regardless if the device is online or offline. The information from the user device can be communicated to the backend server when connectivity is established and/or can be communicated based on a cost verses value analysis.

### BACKGROUND

Computing devices are commonly utilized by users to communicate almost instantaneously with one or more persons or contacts and/or a backend business system. Such information exchange can occur by a user entering information (e.g., text, visual, audio, and so on) into a display area of a user device and communicating with the one or more contacts and/or systems in a back-and-forth manner without using a telephone or other method of communication. This almost instantaneous communication allows a user and various contacts and/or systems in disparate locations to communicate in a real time fashion. It also allows other systems, such as an “intelligent receiving dock”, to send business transactions to a main business backend system based on previous knowledge about incoming orders.

As computing devices become prevalent in the business world, companies are realizing the benefit of providing the work force access to its business solution through these devices. This enables the services and information of a business solution to be readily available from a device, improves productivity and reduces expenses. However, these systems contain a tremendous amount of information and functionality and, therefore, the needed amount of computing space can become quite large, which can be a heavy load for some devices. Thus, providing the work force with all the information and functionality of a business may complicate matters and filtering through the information becomes time consuming. Thus, workers should be given only the information and functionality needed to adequately perform the task.

A challenge in a mobile environment is network connectivity. There are times when a network connection is not available, especially for the mobile worker who is moving in and out of zones of connectivity. To effectively perform their job functions, these workers need access to utilize the business solutions functionality, whether or not they have a network connection.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its purpose is to present some concepts of the described embodiments in a simplified form as a prelude to the more detailed description that is presented later.

In accordance with one or more embodiments and corresponding disclosure thereof, various aspects are described in connection with a mobile framework that can allow the mobile worker to work offline as well as online in a seamless and transparent manner. Reliable network communication is provided as the worker is moving in and out of zones of connectivity. In addition, the various aspects integrate with business solutions.

In accordance with some embodiments, a device user is provided a seamless and transparent online to offline connectivity with a backend server. The user is provided access to the most up to date information and software when connected (e.g., online) while allowing the device to integrate with different types of backend systems. The business logic stored on the device can be maintained at as low a level as possible. The integrity of data transmissions over the network is provided. In accordance with some embodiments, the cost of connecting to the network is mitigated.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system for seamless transitioning between offline and online communication in a seamless and transparent manner.

FIG. 2 illustrates another system for seamless transmission and communication of data with occasionally connected devices.

FIG. 3 illustrates a system architecture that can be employed with the disclosed embodiments.

FIG. 4 illustrates an exemplary request document.

FIG. 5 illustrates a system that can be utilized by an occasionally connected edge component to determine when information should be transmitted to a backend system.

FIG. 6 illustrates a method for transmitting data from a backend server to an occasionally connected client.

FIG. 7 illustrates a method for communicating data from a device to a backend server.

FIG. 8 illustrates a method for receiving information from an occasionally connected edge device.

FIG. 9 illustrates a method for determining an optimal time to send information to a backend server to mitigate costs associated with sending the information.

FIG. 10 illustrates a block diagram of a computer operable to execute the disclosed embodiments.

FIG. 11 illustrates a schematic block diagram of an exemplary computing environment operable to execute the disclosed embodiments.

### DETAILED DESCRIPTION

Various embodiments are now described with reference to the drawings. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed embodiments.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

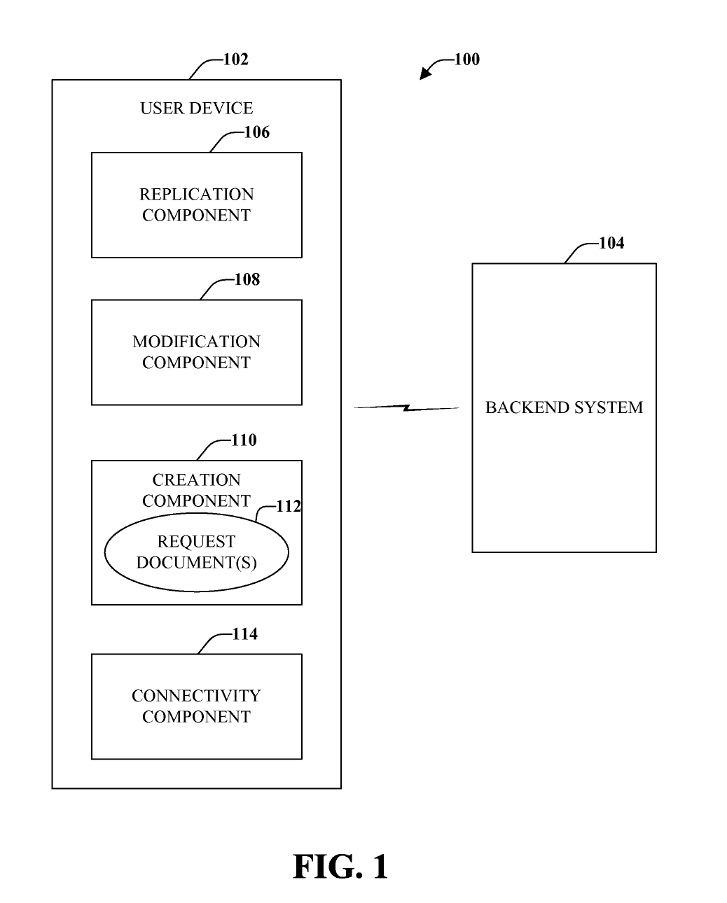

Referring initially to FIG. 1, illustrated is a system 100 for transitioning between offline and online communication in a seamless and transparent manner. System 100 can be configured to allow a user device to connect to and communicate with backend business solutions (e.g., a server at work). Data can be exchanged between the device and the backend server through various types of networks, including, but not limited to WiFi, General Packet Radio Service (GPRS), Enhanced Data for GSM Evolution (EDGE) and so forth. System 100 can allow a user of device to work either online or offline in a seamless, transparent manner.

System includes a user device 102 that can communicate (e.g., wired or wireless) with a backend server 104. The device 102 can be a device that is occasionally connected to the backend server 104. That is to say, device 102 can communicate with backend server 104 directly, when there are periods of connectivity (e.g., an Internet connection) and can work offline when there are periods of non-connectivity (e.g., no connection available). The backend server 104 can process requests from the device 102 and update a business solution based in part on information received from the device 102.

Device 102 can include a replication component 106 that can be configured to store a replication of a filtered down (e.g., mini) version of the information contained in the backend server 104 (e.g., business data). This replication or filtered down data can be data that the user of the device can find useful to perform functions with the device or other data determined to be relevant for the device user. The replication data can be data requested by the device user.

Also included is a modification module 108 that can be configured to receive and maintain data input and/or transactions performed with the device 100. That is to say, modification module 108 can be configured to maintain data changes to the subset of business data. Such transactions can include updating customer information, placing an order, entering repair information or other inputs. This information can be maintained by the modification module 108 but does not change the replication data.

The input data and/or transactions can be analyzed by a creation component 110 that can be configured to generate a document, referred to as a request document 112, which contains the input and/or transaction data (e.g., the data changes maintained by the modification module 108). The creation component can generate the at least one request document though utilization of at least one orchestrations and at least one tasklet (which will be discussed in further detail below). This request document can be generated as a XML document or other type of document (e.g., binary file, database, plain text file, and so forth). The request document can be placed in a queue, storage device and so forth.

The request documents 112 can be selectively sent to the backend server 104 by connectivity component 114 when there is a connection available to communicate with the backend server 104. For example, the request documents 112 can be maintained in a storage media associated with the device. When a period of connectivity is established, the request documents 112 can be sent individually or in conjunction with other request documents (e.g., as a group) or in another format. In some embodiments, various criteria can be utilized to determine whether a particular request document 112 should be sent to the backend server 104 during a connectivity period. Such criteria can take into account a value associated with the request document 112, a cost of the connection, an amount of data to be transferred, as well as other factors.

Thus, system can allow the user to continue to operate and perform functions with the device 102 regardless of whether the device is currently connected or in communication with the backend server 104. If the device has an active connection, processing of request documents 112 can occur at substantially the same time they are created or can be sent based on other criteria (e.g., cost factors). If the device does not have an active connection, the request documents 112 can be maintained until a next optimal period of connectivity. The backend server 104 can process the information in the request documents, which will be further discussed in the following figure.

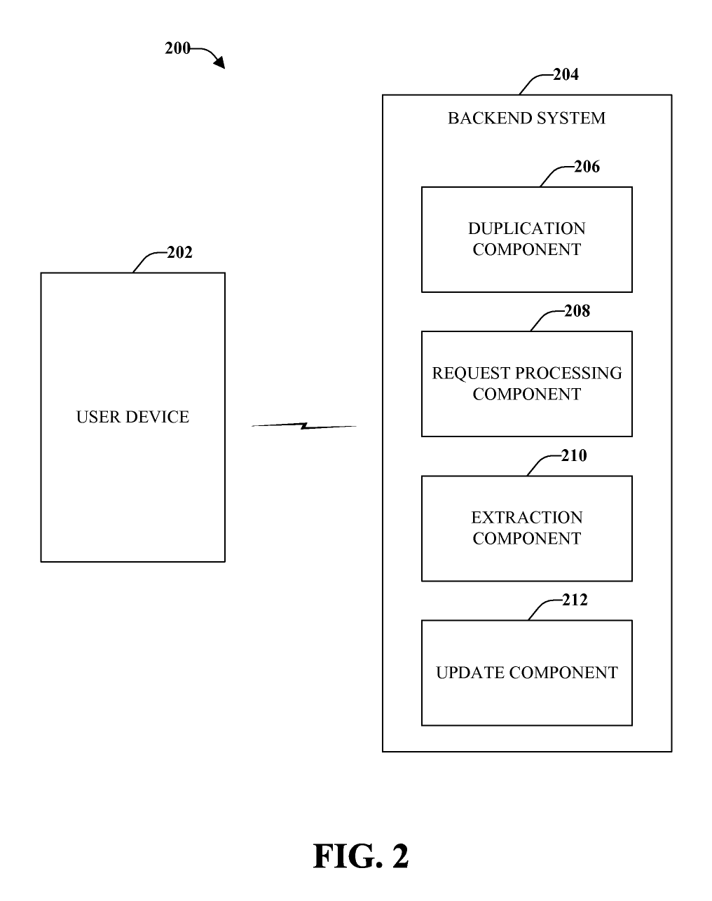

FIG. 2 illustrates another system 200 for seamless transmission and communication of data with occasionally connected devices. System 200 includes a device 202, similar to the device of the above figure, and a backend server 204. Backend server 204 can include a duplication component 206 that can be configured to duplicate at least a portion of the information (e.g., business solution) contained on the backend server 204 to be supplied to the device 202. For example, the backend server 204 may contain a database that can be around 40 GB in size. Since this is a tremendous amount of data to be contained in the device, a subset of that data, such as 20 MB, might be the information needed by the user of the device. Thus, it is only this subset of data that is replicated on the device.

A request processing component 208 can be configured to match a request document received from the device 202 with a system contained in the backend server 204. Since different devices can receive different duplication/replication data from the backend server 204, when information is received from the devices, the backend server 204 should be able to determine which device sent the information and the purpose of the information.

Also included on the backend server 204 can be an extraction component 210 that can be configured to identify and remove the relevant portions of information received from the device (e.g., request documents). An update component 212 can be configured to update the appropriate database with the relevant portions of the data.

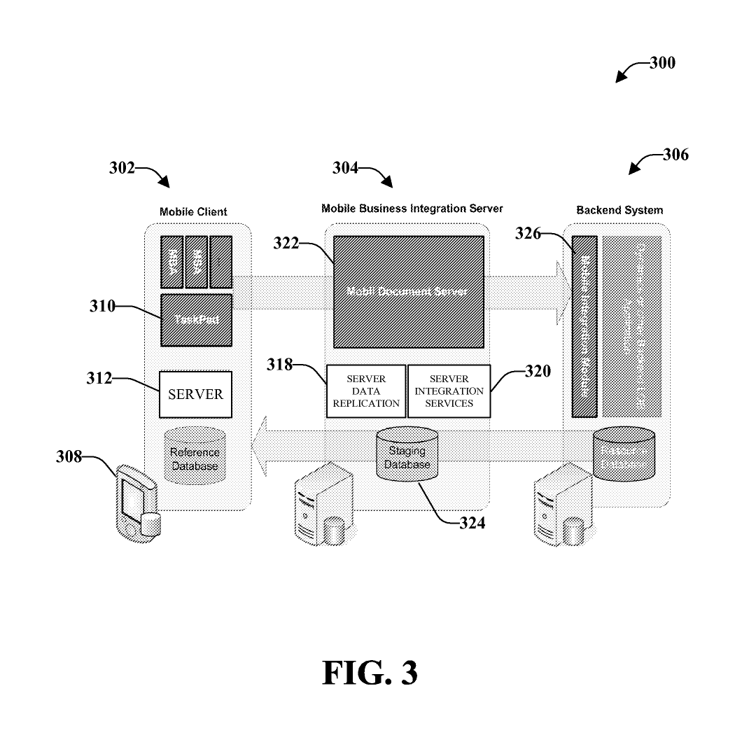

FIG. 3 illustrates a system architecture 300 that can be employed with the disclosed embodiments. This architecture can be divided into a number of tiers or sections. The illustrated system architecture 300 is divided into three tiers: a mobile client 302, a mobile business integration server 304, and a backend system 306.

The mobile client 302 can be any user device and is not limited to the mobile device 308 illustrated. The mobile client 302 can include mobile application software, such as the illustrated “TaskPad” mobile application software 310. Also included is a server 312, which can be any type of server. A reference database 314 can be a filtered down replication (e.g., copy) of information maintained by a resource database 316 included in the backend system 308. Including a portion or filtered down version of the resource database 316, can allow access of the reference database 314 to be faster than going over the network and obtaining the information from the resource database 316. This can also provide the user access to information even if the user is working offline. Thus, the use device can include the data necessary for performing tasks.

The mobile business integration server 304 can include a number of servers, illustrated as a server data replication 318 and a server integration service 320. The server data replication 318 can be utilized to copy the staging database to the user device. The server integration service 320 can be configured to extract a subset of the resource database and save the subset to the staging database.

Also included can be a mobile document server 322, which can be any type of web service. The mobile document server 322 can be responsible for forwarding requests sent from the mobile client 302 to the back end system 304. The mobile document server 322 can also control the deployment of mobile applications to the mobile client 302. Thus, the mobile document server 322 can handle the communication between the user device and the backend system. The mobile document server 322 can also be configured to receive request documents from a user device and parse them to a document dispatcher. The document dispatcher can be configured to read or interpret and pass the request documents to the appropriate backend connector. The backend connector can be configured to process request documents and send the documents to a document handler on the backend. The document handler can be configured to processes the request documents.

A staging database 324, included on mobile business integration server 304, can include a subset of the resource database 316. The staging database 324 can be configured to supply the mobile client 302 with the latest data in a format understandable by the mobile client 304. Depending on the backend system 308, data from the resource database might need some modifications, which can be facilitated by staging database 324.

To communication with the mobile business integration server 304, the backend system 306 can employ a mobile integration module 326. The integration module 326 can be configured to process requests from the mobile client 302 and update the business solution, as appropriate. The open architecture can allow for developing integration components for other systems.

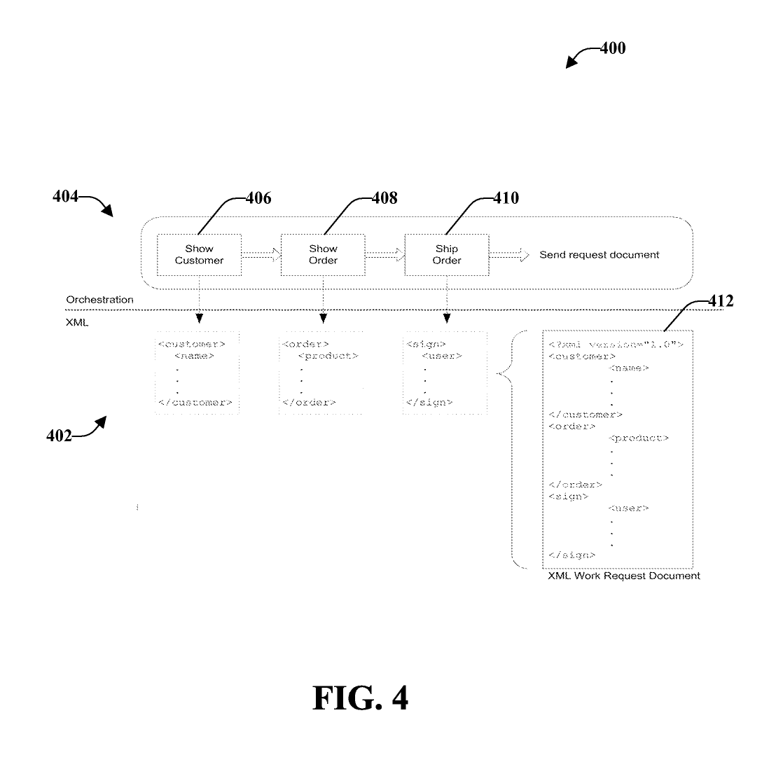

FIG. 4 illustrates an exemplary request document 400. A request document 400 can represent a transaction (from a user device) that can be interpreted and processed by a backend system. A request document can be in various formats (e.g., plain text file, XML, database and so forth). An XML file 404 is illustrated for simplicity of describing the request document. The particular formation utilized should facilitate the correct business logic of a backend system being applied while mitigating replication of the business logic on the user device. The request document 400 illustrated is a process for an orchestration utilized to ship an order.

The request document 400 can be configured utilizing a combination of one or more orchestrations 404 and one or more tasklets, illustrated at 406, 408 and 410. A business solution can be broken up into smaller parts, which can be referred to as blocks, sub-portion, subcomponent, subset (of an application) or a “tasklet” (e.g., a little or small portion of a task) throughout this detailed description. Tasklets can be represented as blocks of applications that can include a series of intuitive, menu-driven screens that the user can navigate to view information and exchange data with the backend business solution (not shown). These blocks (or tasklets) can be reusable in the same or a different application/business solution and can represent a single dialog page and/or function. Breaking down the complexity of a business solution into these blocks can enable easy to configure and implement customer/user/role specific flows.

An orchestration can interface with the individual blocks to piece the blocks together into different configurations. This gathering of blocks can create a personalized, role-based application that can be installed on a device-by-device basis. For example, one device might be for a worker that gathers water meter readings at customers' houses and another worker might service water pipelines in the event a water pipeline breaks. Each worker can be provided different blocks and/or flows relating to the water company services. The first worker can be provided the flow relating to the water meters that are to be read that day and a means for capturing the information and submitting it to the main facility. The second worker can be provided a flow relating to the location of the pipeline needing maintenance, the type of maintenance needed and a means for entering the work performed, the hours worked, the supplies used and so forth.

The orchestration can define the request document for a group of tasklets, which can contribute input to the request document 400. As a user navigates through an orchestration on a device, each tasklet can output data that can be serialized into a block of the request document. The individual blocks can be combined into a singe request document 412 (e.g., work document) that can be sent to a backend server for processing. It should be noted that a handler at the backend could be implemented to process a request document and to map the input to the proper logic of the business solution.

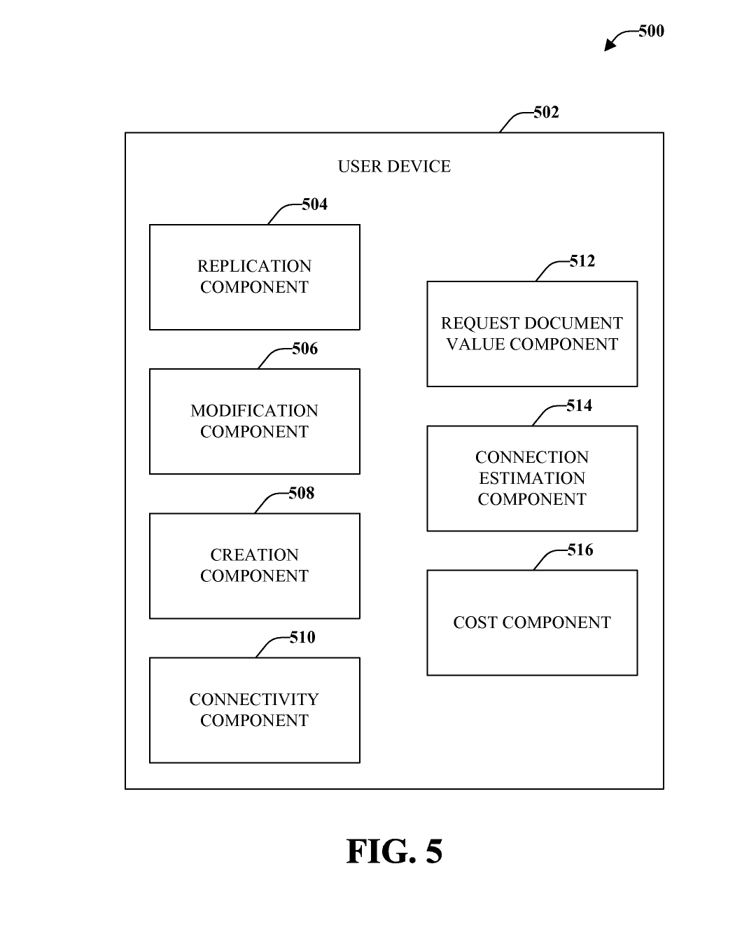

FIG. 5 illustrates a system 500 that can be utilized by an occasionally connected edge component to determine when information should be transmitted to a backend system. System 500 can be included on a mobile device 502 to determine when a request document should be sent to the backend system based on various factors including the importance of the information in the request document, the cost of the connection, the amount of data to be sent as well as other factors.

Included in system 500 can be a replication component 504 that can be configured to store a replication of a filtered down (e.g., mini) version of the information contained in the backend server. Also included is modification component 506 that can be configured to receive and maintain data input and/or transactions performed with the device 502.

Also included in system 500 can be a creation component 508 that can be configured to generate a document (e.g., request document), which can contain the input and/or transaction data. The request documents can be sent to the backend server by a connectivity component 510 when there is a connection available to communicate with the backend server.

In some embodiments, other criteria can be utilized to determine whether a particular request document should (or should not be) sent when there is an available connection. A request document value component 512 can be configured to determine a value of a request document. The determination made by the request document value component 512 can take into account the value of the data contained in the request document. This value can be based in part on the type of data input into the document, the amount of changes or updates included in the document, historical data relating to similar input or transactions included in the document or based on other factors or criteria.

In some embodiments, the value determination is made based on a manual configurable setting provided for a particular input and/or transaction. For example, a user can interact with system 500 through an interface component and/or display component. For example, system can provide a graphical user interface (GUI), a command line interface, a speech interface, Natural Language text interface, and the like. For example, a GUI can be rendered that provides a user with a region or means to load, import, select, read, etc. the value of a particular input, transaction or other information and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The user can also interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed embodiments are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

Also included in system can be a connection estimation component 514 that can be configured to determine an estimated expense of sending information over a particular connection. For example, each network connection type can be assigned a value (e.g., expense value). This value can correspond to the relative cost of the connection and, the higher the value, the less desirable that connection might be for some request documents.

A cost component 516 can be provided that can determine other costs with sending one or more request document during a period of connectivity. For example, cost component 516 can take into account the amount of data to be sent and the cost of sending that data. Cost component 516 can take into account the type of data being sent and the value of that type of data. If the value of the request document is equal to or greater than the value assigned by the connection estimation component 514 and/or the cost component 516, then the request document can be sent. If the value of the request document is less than the value assigned by the connection estimation component 514 and/or the cost component 516, then the request document can remain in a queue associated with the user device, until such time as it is determined that the request document should be sent.

In some embodiments, a machine-learning component (not shown) can be utilized to determine when to send a request document in accordance with the disclosed embodiments. The machine-learning component can employ various machine learning techniques, algorithms, approaches, etc. to identify and/or detect text in data. For example, the machine-learning component can employ a machine-learning algorithm that can reason about or infer text in data from a set of observations, features, properties, and/or components of the data. Inference can be employed to identify a context and/or can generate a probability distribution over the input data and/or components identified within this input as potential text. Such inferences can be probabilistic—that is, the computation of a probability distribution over entities identified within the data. Inference can also refer to techniques employed for rendering higher-level decisions.

Various classification (explicitly and/or implicitly trained) schemes and/or systems (e.g., boosting classifiers, transduction classifiers, inductive classifiers, support vector machines, neural networks, expert systems, Bayesian belief networks, fuzzy logic, data fusion engines . . . ) can be employed in connection with performing automatic detection of text in accordance with the subject embodiments. In general, a classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to automatically differentiate text from other entities within an image. One example of a suitable classifier is a support vector machine (SVM), which, in general, operates by finding a hypersurface, which attempts to split triggering criteria from non-triggering criteria, in the space of possible inputs. This can make the classification suitable for testing samples, data, etc. that is near, but not identical to training data. Other directed and undirected model classification approaches include, naïve Bayes, Bayesian networks, decision trees, neural networks, fuzzy logic models, and probabilistic classification models providing different patterns of independence, for example. Classification as used herein also is inclusive of statistical regression that is utilized to develop models of priority.

In view of the exemplary systems shown and described, methods that may be implemented in accordance with the disclosed subject matter, will be provided. While, for purposes of simplicity of explanation, the methods are shown and described as a series of blocks, it is to be understood and appreciated that the disclosed embodiments are not limited by the number or order of blocks, as some blocks may occur in different orders and/or concurrently with other blocks from what is depicted and described herein. Moreover, not all illustrated blocks may be required to implement the methods described hereinafter. It is to be appreciated that the functionality associated with the blocks may be implemented by software, hardware, a combination thereof or any other suitable means (e.g. device, system, process, component). Additionally, it should be further appreciated that the methods disclosed hereinafter and throughout this specification are capable of being stored on an article of manufacture to facilitate transporting and transferring such methods to various devices. Those skilled in the art will understand and appreciate that a method could alternatively be represented as a series of interrelated states or events, such as in a state diagram.

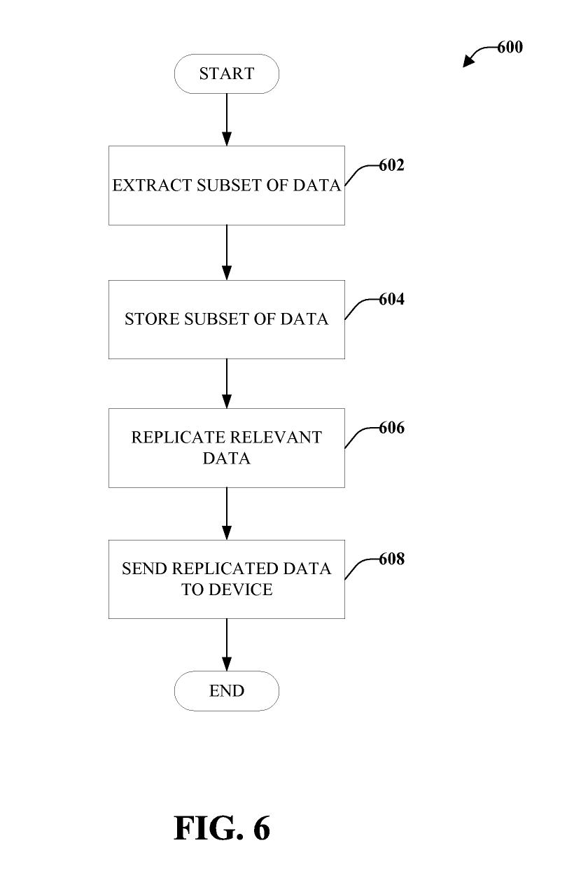

FIG. 6 illustrates a method 600 for transmitting data from a backend server to an occasionally connected client. Method 600 begins, at 602, when a subset of data is extracted (e.g., extract, transform, load) from an information database. This information database can include all or a portion of the information relating to a particular entity (e.g., business, organization, government agency, personal information, and so forth). At 604, the subset of data is stored, such as in a queue or storage media.

Data relevant for a user device is replicated, at 606. This replicated data can be a filtered down version of a database that can be sent to the user device, at 608. The filtered down version provides a reduction in size of the data from the backend server to the device. This reduction in size can be significant, which can be useful for the user device to perform efficiently while mitigating usage of system resources. For example, a typical resource database located on a backend server might be around 40 GB and the corresponding reference database might be around 20 MB, for example. This reduction can mitigate the bandwidth used for transmitting over the network, which can increase reliable and lower costs.

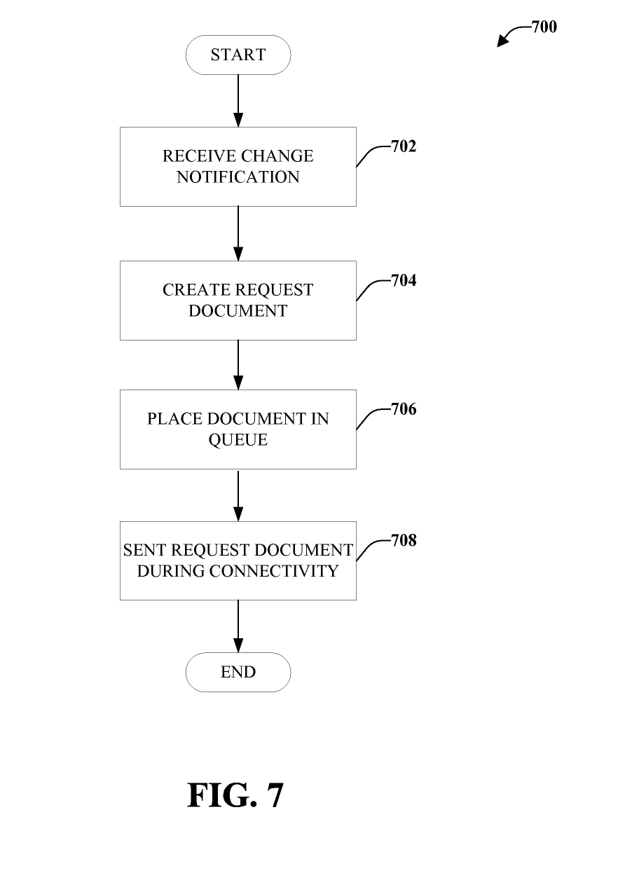

FIG. 7 illustrates a method 700 for communicating data from a device to a backend server. This data can be communicated in the form of a request document. At 702, a data change notification is received. This change notification can be received each time there is a change to the data or when an event occurs.

For example, an intelligent RFID reader (which is another example of a user device) can make a decision and when a condition is met, a notification (e.g., request document) can be sent to the backend server. The RFID reader can monitor a shelf in a warehouse that contains a particular quantity (e.g., 20) of a certain product. The reader can detect or read each time a product is removed and/or placed on the shelf (e.g., if a product is used and/or replaced). A business solution might relate to maintaining enough products on the shelf to meet customer needs. If it takes a week to replace a quantity of the product, and 5 pieces are used in a week, the RFID reader might not notify the backend system until the quantity falls below the threshold level (e.g., 5 pieces). In such a manner, the backend system does not have to be notified of each event, but simply when a certain condition is met (e.g., there are only 5 pieces left on the shelf).

At 704, a request document is created based on the triggering event. The request document is placed in a queue or other storage media, at 706, (if the device is offline) until it is determined that the document should be sent to the backend server. For example, the request document might not be sent until there is a period of connectivity (e.g., for a device that is operating offline). In some embodiments, the request document might be held until it is cost-effective to send such document to the backend server. The request document is selectively sent, at 708, during one or more periods of connectivity. In some embodiments, a subset of the request documents can be sent while other request documents are maintained until a subsequent period of connectivity.

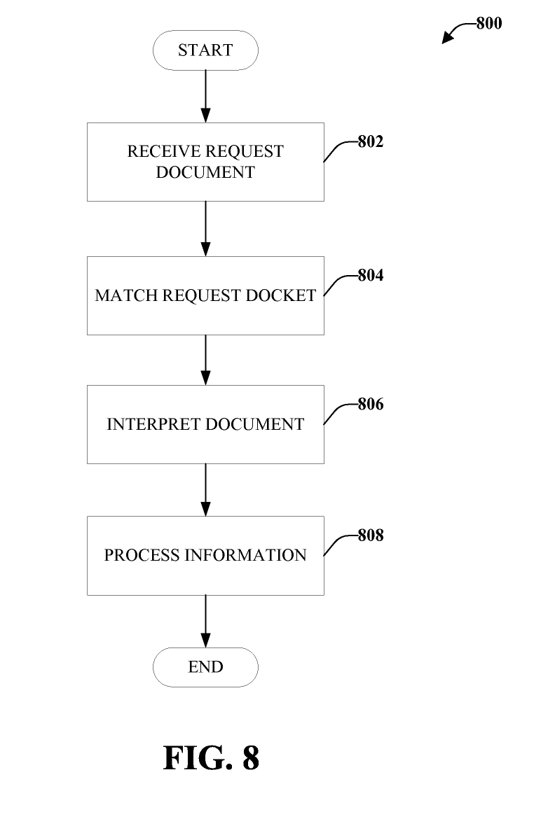

FIG. 8 illustrates a method 800 for receiving information from an occasionally connected edge device. At 802, one or more request documents are received from a mobile device. The request document(s) can include data input and transactions performed on the device. At substantially the same time the request document is received, it is matched, at 804, with its corresponding backend system. Thus, there should be information included in the request document that identifies the device that sent the document as well as the business solution relating to information provided by the device. At 806, the information contained in the request document is interpreted and the information is processed, at 808. Thus, the business solution can be updated with the information received from the user device.

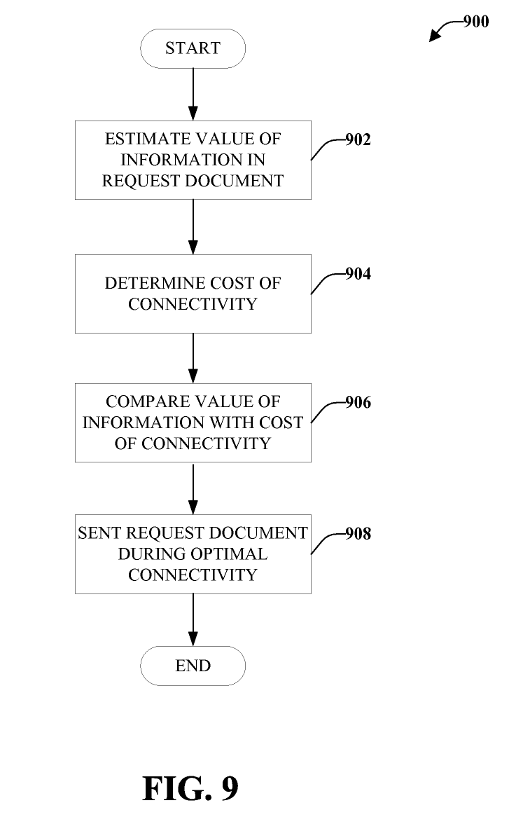

FIG. 9 illustrates a method 900 for determining an optimal time to send information to a backend server to mitigate costs associated with sending the information. Method 900 starts, at 902, when information contained in a request document is assigned an estimated value. The request document can be placed in a queue on the user device as it awaits action. If there is a network connection, the request document can be communicated to the backend server. If there is no network connection, the request document can remain in the queue until a connection is available. A request document can allow users to perform transactions even if there is no current online connect (e.g., working offline). These transactions can be dispatched later, when a network connection is available (e.g., online).

The queue can also be utilized as a means to control network costs by mitigating the number of request documents dispatched over high cost networks. User devices can support a number of network connection types (e.g., EDGE, GPRS, WiFi, Desktop Pass Through (DTPT) and so forth). The cost of using these connections can vary, with EDGE typically being more expensive and DTPT being less expensive. Thus, at 904, the cost of connectivity can be determined. This cost can be prioritized on a rating scale (e.g., 1 through 10 with 10 being the most expensive) or other means.

The value of information included in the request document is compared with the cost of connectivity, at 906. At 908, the request document is sent during optimal connectivity based on value versus cost. Prioritization of when request documents are sent can be based on the most cost effective means of communicating the information. Thus, costs can be controlled while allowing a device to communicate data when the device has connectivity with a backend server.

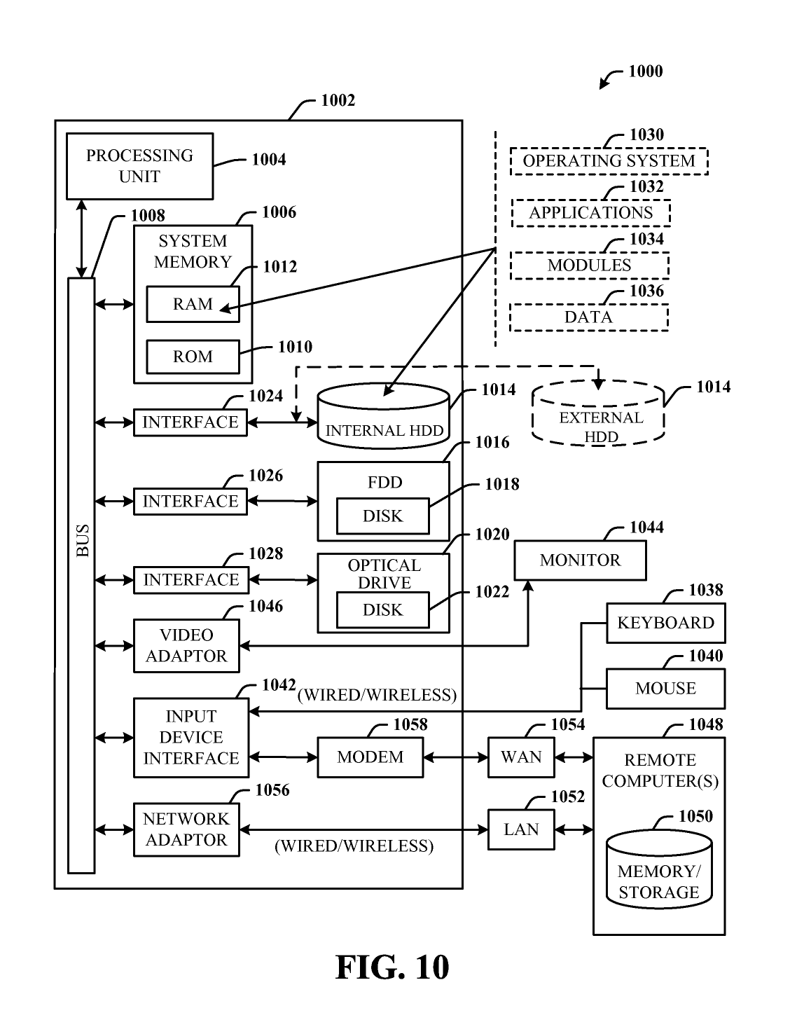

Referring now to FIG. 10, there is illustrated a block diagram of a computer operable to execute the disclosed architecture. In order to provide additional context for various aspects disclosed herein, FIG. 10 and the following discussion are intended to provide a brief, general description of a suitable computing environment 1000 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the various embodiments can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 through an interface, such as a video adapter 1046. In addition to the monitor 1044, a computer typically includes other peripheral output devices (not shown), such as speakers, printers, etc.

The computer 1002 may operate in a networked environment using logical connections through wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, is connected to a communications server on the WAN 1054, or has other means for establishing communications over the WAN 1054, such as by way of the Internet. The modem 1058, which can be internal or external and a wired or wireless device, is connected to the system bus 1008 through the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

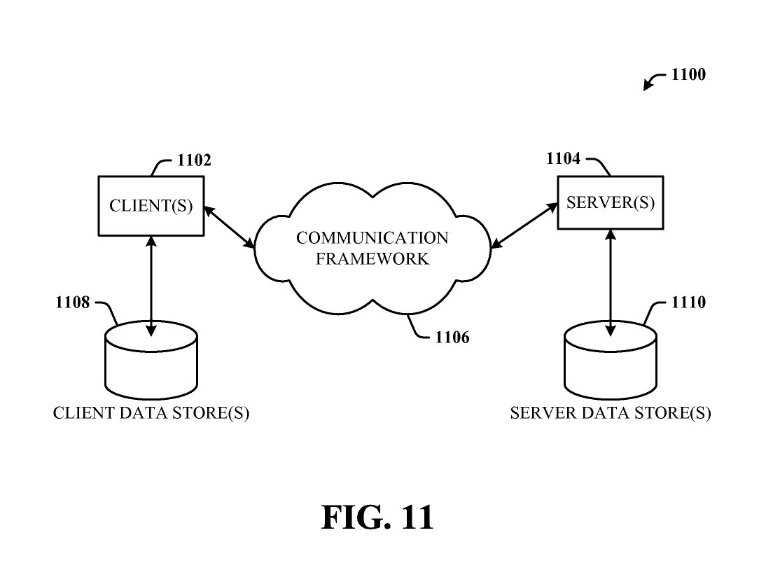

Referring now to FIG. 11, there is illustrated a schematic block diagram of an exemplary computing environment 1100 in accordance with the various embodiments. The system 1100 includes one or more client(s) 1102. The client(s) 1102 can be hardware and/or software (e.g., threads, processes, computing devices). The client(s) 1102 can house cookie(s) and/or associated contextual information by employing the various embodiments, for example.

The system 1100 also includes one or more server(s) 1104. The server(s) 1104 can also be hardware and/or software (e.g., threads, processes, computing devices). The servers 1104 can house threads to perform transformations by employing the various embodiments, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated through a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

What is claimed is:

1. A system for transitioning between offline and online communication in a seamless and transparent manner, comprising:
a replication component that stores a subset of business data;
a modification module maintains data changes to the subset of business data;
a creation component that generates at least one request document that includes the maintained data changes; and
a connectivity component that selectively communicates the at least one request document to a backend server.

2. The system of claim 1, the modification module does not change the subset of business data.

3. The system of claim 1, the at least one request document is placed in a queue until communicated to the backend server.

4. The system of claim 1, the at least one request document is communicated to the backend server or in conjunction with at least a second request document.

5. The system of claim 1, the connectivity component communicates the at least one request document to the backend server when a value of the data outweighs a cost of sending the at least one request document.

6. The system of claim 1, the connectivity component does not communicate the at least one request document to the backend server when a cost of sending that at least one request document outweighs a value of the data contained in the request document.

7. The system of claim 1, the data changes maintained by the modification components include a data input or a transaction.

8. The system of claim 1, the creation component generates the at least one request document though utilization of at least one orchestrations and at least one tasklet.

9. The system of claim 1, the request document is an XML document, a plain text file, a database, or a binary file or combinations thereof.

10. A method for communicating data from a device to a backend server, comprising:
receiving a data change notification to a subset of business information;
creating a request document that includes the data change notification;
storing the request document if a device is offline; and
selectively sending the request document to a backend server when the device is online.

11. The method of claim 10, receiving a data change notification is performed each time there is a data change.

12. The method of claim 10, receiving a data change notification is performed when an event occurs.

13. The method of claim 10, selectively sending the request document comprises determining when it is cost-effective to send the request document.

14. The method of claim 10, creating the request document comprises including at least one orchestrations and at least one tasklet.

15. The method of claim 10, further comprising receiving from the backend server a replication of the at least a subset of business information.

16. The method of claim 10, further comprising:
assigning an estimated value to the request document;
determining a cost of connectivity;
comparing the estimated value to the cost of connectivity; and
selectively communicating the request document to the back end server based on the comparison.

17. The method of claim 16, the request document is communicated to the back end server is the estimated value is greater than or equal to the cost of connectivity.

18. The method of claim 16, the request document is not communicated to the backend server if the estimated value is less than the cost of connectivity.

19. A computer executable system that provides an occasionally connected edge application architecture, comprising:
means for providing at least a subset of business information to a device;
means for selectively receiving a notification of a change intended for the subset of business information from the device.

20. The system of claim 19, further comprising means for updating the business information based in part on the received notification.
